(19) United States
(12) Patent Application Publication
(10) Pub. No.: US 2010/0301245 A1
(43) Pub. Date: Dec. 2, 2010

(54) Assembly For Mounting Of Tube Pinch Type Solenoid Valve

(75) Inventors: Roger W. Accurso, Fremont, CA (US); Kenneth D. Briggs, Gardnerville, NV (US); Gail A. Schooley, Chesapeake, VA (US)

Correspondence Address: PAUL D. YASGER;ABBOTT LABORATORIES, 100 ABBOTT PARK ROAD, DEPT. 377/AP6A, ABBOTT PARK, IL, 60064-6008, US

(73) Assignee: ABBOTT LABORATORIES, Abbott Park, IL (US)

(21) Appl. No.: 12/476,572

(22) Filed: Jun. 2, 2009

(51) Int. Cl. F16K 31/02; F16M 13/00

(52) U.S. Cl. 251/129.15; 248/637

(57) ABSTRACT

An assembly for mounting tube pinch type solenoid valves. The assembly comprises a mounting panel, a rear panel, and at least one rod for connecting the mounting panel to the rear panel. The mounting panel has at least one aperture for receiving a tube pinch type solenoid valve. The rear panel has at least one power jack in register with the at least one aperture. The assembly makes it possible for tube pinch type solenoid valves to be inserted and removed from the front of the mounting panel. The rear panel incorporates an integral solenoid driver module for each solenoid valve in a given assembly. Each integral solenoid drive module can accommodate a plurality of valves. The arrangement provides a sufficient amount of clear space for efficient cooling flow of air between the mounting panel and the rear panel. An unobstructed flow of air is desired in order to dissipate heat generated by the tube pinch type solenoid valves. Also disclosed are tube pinch type solenoid valves comprising a core tube, a core, a core spring, a solenoid enclosure, a slide shaft, an electrical connector, a snap-in mount having at least one flexible mounting ear, and a valve plunger.

### BACKGROUND OF THE INVENTION

1. Field of the Invention

This invention relates to mounting of solenoid valves, and more particularly, mounting of tube pinch type solenoid valves.

2. Discussion of the Art

A solenoid valve is a combination of two functional units: (1) a solenoid operator essentially consisting of a coil, core, and spring(s); (2) a valve body containing orifices in which a disc, diaphragm, or piston, etc., is positioned according to the type of technology used. The valve is opened or closed by movement of the magnetic core, which is drawn into an electromagnetic coil when the coil is energized. A tube pinch type solenoid valve provides full bore flow and extended service life. These features are achieved by means of the pinch device, designed especially top operate smoothly with a balanced load. No pollution is possible, and operation of the valve is silent. The flow of fluid is bidirectional. See, for example, SOLENOID VALVE TECHNOLOGY AND TECHNICAL CHARACTERISTICS, Function, terminology and construction types, ASCO Joucomatic, X006-077-05-1, available at the website www.ascojoucomatic.com/images/site/upload/_en/pdf1/01027gb.pdf, incorporated herein by reference.

Many types of medical analyzers, such as, for example, clinical analyzers, including, but not limited to, clinical chemistry analyzers, immunoassay analyzers, hematology analyzers, e.g., CELL-DYN® hematology analyzers, use tube pinch type solenoid valves. Typically, tube pinch type solenoid valves are mounted in a vertical panel by inserting the valves into openings in the panel by means of mounting nuts. Such a means for mounting the valves requires extensive disassembly of the panel to remove and replace the valves. Each valve contains two long wires that must be routed to solenoid driver modules, i.e., circuit boards having electronic components for driving the solenoid valve. Because solenoid driver modules are frequently mounted in a remote location within the medical analyzer, these wires are difficult to trace for service; furthermore, these wires also block the flow of air within the interior of the medical analyzer into which they are placed.

Accordingly, it would be desirable to provide an arrangement for tube pinch type solenoid valves whereby the valves can be easily installed and removed from a clinical analyzer without tools. It would also be desirable to provide an arrangement for tube pinch type solenoid valves whereby the electrical and mechanical connections therefor can be made simultaneously with ease. It would also be desirable to provide an arrangement for tube pinch type solenoid valves whereby separate wires, connectors, screws, nuts, and the like would not be needed.

### SUMMARY OF THE INVENTION

In one aspect, this invention provides an assembly for mounting tube pinch type solenoid valves. The assembly comprises a mounting panel, a rear panel, and at least one rod for connecting the mounting panel to the rear panel. The mounting panel has at least one aperture for receiving a tube pinch type solenoid valve. The at least one aperture has at least one keyed slot to ensure proper orientation of the tube pinch type solenoid valve. The rear panel has at least one power jack in register with the at least one aperture. The assembly makes it possible for tube pinch type solenoid valves to be inserted and removed from the front of the mounting panel. The two long wires are eliminated by direct electrical connection of the tube pinch type solenoid valve to the rear panel of the assembly. In addition, the rear panel incorporates an integral solenoid driver module for each solenoid valve in a given assembly. Each integral solenoid drive module can accommodate a plurality of valves, such as, for example, as many as 80 solenoid valves. The only cables required for each integral solenoid driver module are a single power/ground cable from the rear panel to a power supply unit and a control cable from the rear panel to a computer controller or circuit board. The arrangement provides a sufficient amount of clear space for efficient cooling flow of air between the mounting panel and the rear panel. An unobstructed flow of air is desired in order to dissipate heat generated by the tube pinch type solenoid valves.

In another aspect, this invention provides a normally open tube pinch type solenoid valve comprising a core tube, a core, a core spring, a solenoid enclosure, a slide shaft, an electrical connector, a snap-in mount having at least one flexible mounting ear, and a valve plunger. The snap-in mount comprises a recess for accommodating tubing, and the at least one flexible mounting ear has a projection for gripping a major surface of the mounting panel. The invention also provides a normally closed tube pinch type solenoid valve comprising a core tube, a core, a core spring, a solenoid enclosure, a slide shaft, an electrical connector, a snap-in mount having at least one flexible mounting ear, and a valve plunger. The snap-in mount comprises a recess for accommodating tubing, and the at least one flexible mounting ear has a projection for gripping a major surface of the mounting panel.

In another aspect, this invention provides a medical analyzer comprising at least one of the aforementioned assemblies for mounting tube pinch type solenoid valves.

### BRIEF DESCRIPTION OF THE DRAWINGS

FIG. 1 is a perspective view of a set of snap-in tube pinch type solenoid valve assemblies positioned in pinch valve assembly holder. In this view, the observer views the valve assemblies from a position before the mounting panel.

FIG. 2 is a perspective view of a set of snap-in tube pinch type solenoid valve assemblies positioned in pinch valve assembly holder, with the rear panel removed. In this view, the observer views the valve assemblies from a position before the rear panel.

FIG. 3 is a front view in elevation of the mounting panel of the tube pinch type solenoid valve assembly holder.

FIG. 4 is a top plan view of a set of snap-in tube pinch type solenoid valve assemblies positioned in pinch valve assembly holder.

FIG. 5 is a side view in elevation of the tube pinch type solenoid valve assembly holder.

FIG. 6 is a cross-sectional view of the tube pinch type solenoid valve assembly taken along line 6-6 of FIG. 3.

FIG. 7 is an exploded perspective view of a normally open tube pinch type solenoid valve assembly. In this view, the observer views the tube pinch type solenoid valve assembly from a position before the mounting panel.

FIG. 8 is an exploded perspective view of the tube pinch type solenoid valve assembly of FIG. 7. In this view, the observer views the tube pinch type solenoid valve assembly from a position before the rear panel.

FIG. 9 is a cross-sectional view of the tube pinch type solenoid valve assembly of FIG. 7 taken along line 6-6 of FIG. 3.

FIG. 10 is an exploded perspective view a normally closed tube pinch type solenoid valve assembly. In this view, the observer views the tube pinch type solenoid valve assembly from a position before the mounting panel.

FIG. 11 is an exploded perspective view of the tube pinch type solenoid valve assembly of FIG. 10. In this view, the observer views the tube pinch type solenoid valve assembly from a position before the rear panel.

FIG. 12 is a cross-sectional view of the tube pinch type solenoid valve assembly of FIG. 10 taken along line 6-6 of FIG. 3.

FIG. 13 is a top plan view of a snap-in mount suitable for use in the assembly described herein.

FIG. 14 is a side view in elevation of the snap-in mount of FIG. 13.

FIG. 15 is a cross-sectional view of the snap-in mount of FIGS. 13 and 14 taken along line 15-15 of FIG. 13.

FIG. 16 is a perspective view of the snap-in mount of FIG. 13. In this view, portions of the snap-fit mount are cut away so that the details of the valve seat or anvil can be seen.

FIG. 17 is a schematic diagram illustrating the connections between a power supply unit, a plurality of assemblies for mounting tube pinch type solenoid valves, and a computer for communication with the various solenoid driver modules to determine the actuation and the timing of solenoid valves.

### DETAILED DESCRIPTION

As used herein, the expression “tube pinch type solenoid valve” means a solenoid valve having a pinch device designed to provide full bore flow (1.e., no idle volume). As used herein, the term “valve body” means the part of the valve that includes the pinch device. As used herein, the term “coil” means the electrical part of the valve consisting of a spool wound with insulated copper wire for creating magnetic flux wherein energized. As used herein, the term “core” means a movable ferromagnetic rod, which is movable by magnetic forces. As used herein, the expression “core spring” means a spring that keeps the core in fixed position when the coil is de-energized. As used herein, the expression “solenoid enclosure” means the metal housing around the coil for electrical and mechanical protection, as well as protection against ingress of water or dust. As used herein, the expression “valve plunger” means a component that operates with a repeated thrusting movement, similar to that of a piston, in order to open, close, and regulate flexible tubing. As used herein, the term “solenoid plunger” means a component that operates with a repeated thrusting movement, similar to that of a piston, in order to move the valve plunger. As used herein, the expression “rear cap” means the component of a tube pinch type solenoid valve that holds and supports an electrical connector. As used herein, the expression “electrical connector” means the component of a tube pinch type solenoid valve that mates with a power jack. An example of an electrical connector suitable for use herein is a plug connector.

As used herein, the expression “solenoid driver module” means a circuit board that provides the appropriate voltage(s) to actuate a solenoid valve in response to a signal voltage. As used herein, the expression “integral solenoid driver module” means a solenoid driver module in which the electronic circuitry that drives the solenoid valve is integrated into the panel that contains the electrical connector, i.e., a power jack. A typical non-integral solenoid drive module utilizes a long cable having a connector that is connected to a remote location where the solenoid drive module is located. The integral solenoid driver module eliminates the long cable and remote location of the solenoid driver module. As used herein, the expression “driver circuitry” means the circuitry of a solenoid driver module or integral solenoid driver module. The driver circuitry is a group of circuits containing electronic components that take a control signal from a computer and convert that signal to voltages to actuate solenoid valves. The computer provides signals to the driver circuitry to control numerous valves simultaneously, based on the need of the instrument. As used herein, the expression “power supply unit” means a device or system that supplies electrical or other types of energy to an output load or group of loads.

As used herein, the expression “medical analyzer” means a clinical analyzer, including, but not limited to, clinical chemistry analyzers, immunoassay analyzers, and hematology analyzers.

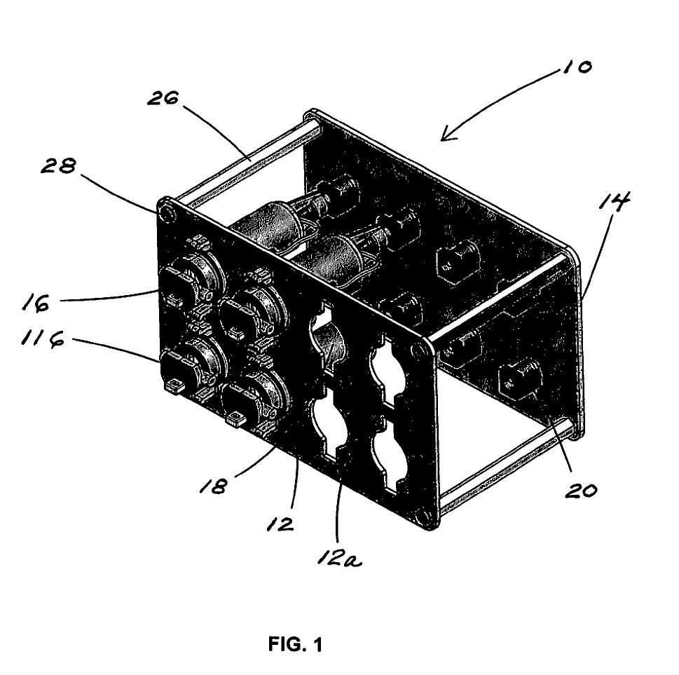

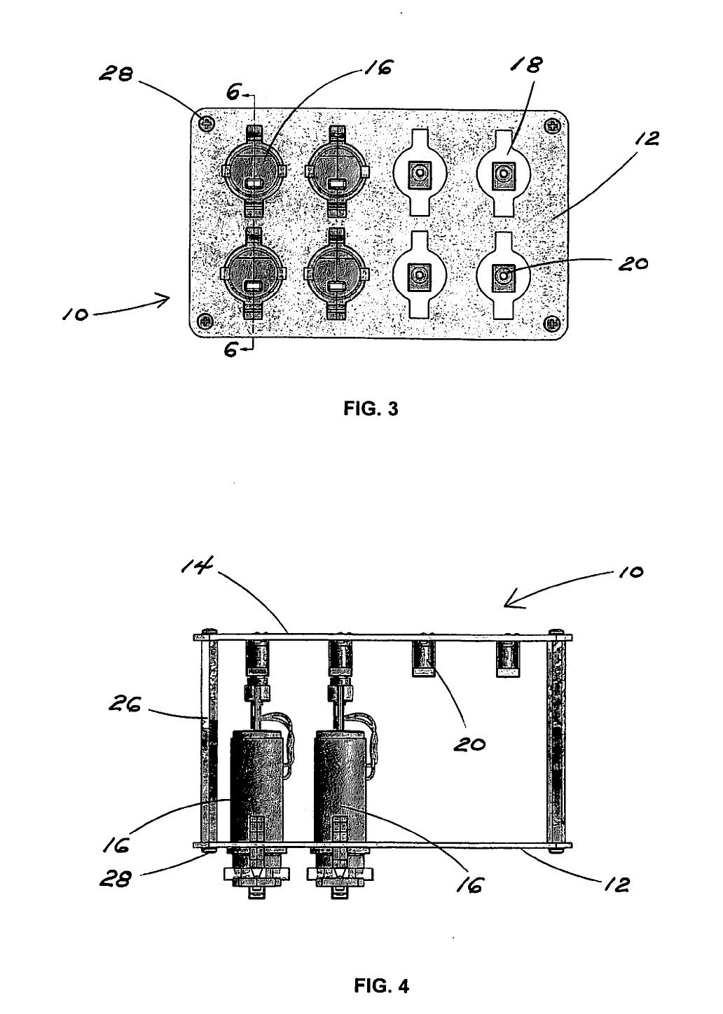

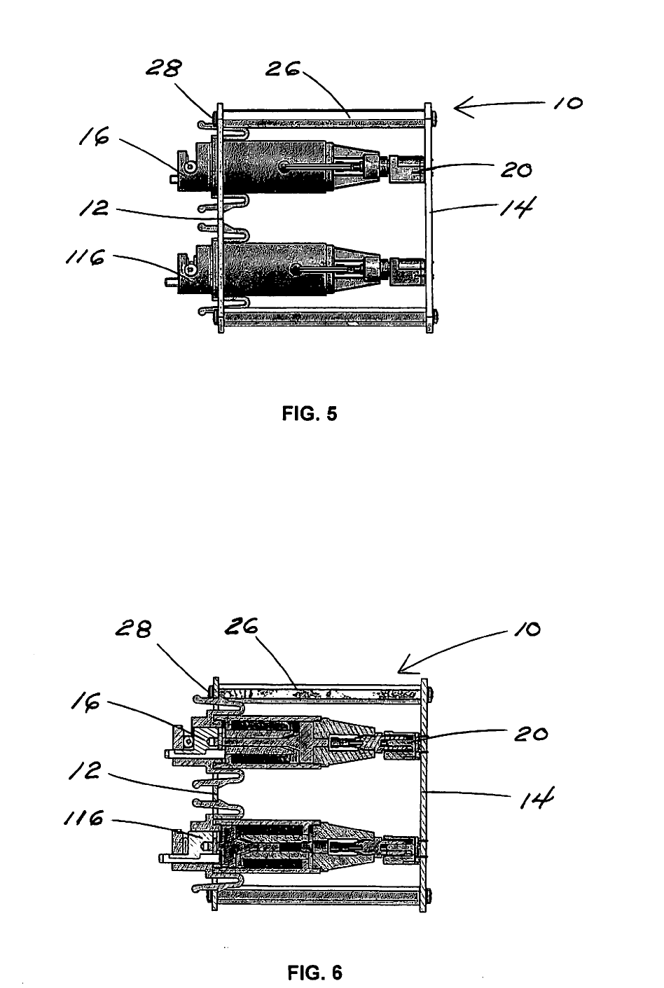

In the drawings, to the extent possible, like parts have like reference numerals. In FIGS. 1, 2, 3, 4, 5, and 6 only one of the two or more identical parts shown will be marked with reference numerals. Referring now to FIGS. 1, 2, 3, 4, 5, and 6, an assembly 10 for mounting tube pinch type solenoid valves comprises a mounting panel 12, a rear panel 14, and at least one tube pinch type solenoid valve 16, which valve can be inserted into an aperture 18 in the mounting panel 12 and plugged into a power jack 20 in the rear panel 14. In FIGS. 1, 2, 3, 4, 5, and 6, two types of tube pinch type solenoid valves are shown, a normally open tube pinch type solenoid valve 16 and a normally closed tube pinch type solenoid valve 116. The differences between these two types of tube pinch type solenoid valves are discussed later. In the discussion of FIGS. 1, 2, 3, 4, 5, and 6 the normally closed tube pinch type solenoid valve 116 is only discernible in FIG. 6; the normally open tube pinch type solenoid valve 16 is discernible in FIGS. 1, 2, 3, 4, 5, and 6. The tube pinch type solenoid valve 16 can be plugged into a power jack 20 in the rear panel 14 when the tube pinch type solenoid valve 16 is properly inserted into the mounting panel 12. Driver circuitry 24 for driving the tube pinch type solenoid valve is built into the rear panel 14, rather than using a separate driver module that is mounted in a remote location. A plurality of tube pinch type solenoid valves 16 can be accommodated in the assembly 10. The mounting panel 12 has the function of supporting the tube pinch type solenoid valves 16 and guiding the electrical connections of the tube pinch type solenoid valves 16 into the power jacks 20. As shown in FIGS. 1, 2, and 3, the mounting panel 12 has sufficient apertures 18 for eight (8) tube pinch type solenoid valves. However, other mounting panels (not shown) can accommodate a lesser or greater number of apertures 18 for a lesser or greater number of tube pinch type solenoid valves.

The mounting panel 12 is typically made of a non-corrosive metallic material, such as, for example, aluminum, stainless steel. The material of the mounting panel 12 should have sufficient rigidity in order to have the strength to support a plurality of tube pinch type solenoid valves 16. Accordingly, the thickness of the mounting panel 12 should be sufficient to impart the required amount of rigidity to the mounting panel 12. The mounting panel 12 should be of sufficient size to support the number of tube pinch type solenoid valves 16 desired.

The rear panel 14 is typically made of the type of material that is used to prepare circuit boards. A representative example of a material suitable for preparing the rear panel 14 is a combination of glass, typically fiberglass, and epoxy resin. The rear panel 14 should be of sufficient size to accommodate the number of power jacks 20 desired.

The mounting panel 12 is connected to the rear panel 14 by means of at least one connecting rod 26, typically a plurality of connecting rods 26. The connecting rods 26 typically have threaded ends. A threaded end can be within the interior of the connecting rod 26; alternatively, a threaded end can be on the exterior of the connecting rod 26. If the threaded end is within the interior of the connecting rod 26, a threaded bolt 28 can be used to secure the mounting panel 12 or the rear panel 14 to the connecting rod 26.

Alternatively, if the threaded end is on the exterior of the connecting rod 26, a threaded nut (not shown) can be used to secure the mounting panel 12 or the rear panel 14 to the connecting rod 26.

Each aperture 18 in the mounting panel 12 is in register with a power jack 20 in the rear panel 14. The power jack 20 receives an electrical connector located at the rear end of the tube pinch type solenoid valve 16. The particular specifications for the electrical connector and the power jack are not critical. However, a representative example of an electrical connector is a plug connector, designated as part no. PP3-002B, commercially available from CUI, Inc., Tualatin, Oreg., described in DC Power Plugs & In-Line Receptacles CUI Inc. at http://www.cui.com/showprods.aspx/cid=1239&level=3, incorporated herein by reference. A representative example of a power jack is part no. PJ-044B, commercially available from CUI, Inc., Tualatin, Oreg., described in 2.5 mm Center Pin CUI Inc. at http://www.cui.com/showprods.aspx/cid=1259&level=3, incorporated herein by reference. The plug connector PP3-002B is a barrel plug connector and the power jack PJ-044B is a center pin power jack. Plug connectors and power jacks are further described in DC connector—Wikipedia, the free encyclopedia, at http://en.wikipedia.org/wiki/DC_connector, incorporated herein by reference. As shown in FIGS. 1, 2, and 3, each aperture 18 has a first slot 18a on the periphery thereof and a second slot 18b on the periphery thereof, the first slot 18a being of a width that is different from the width of the second slot 18b, thereby providing a keyed orientation to prevent incorrect installation of the tube pinch type solenoid valve 16.

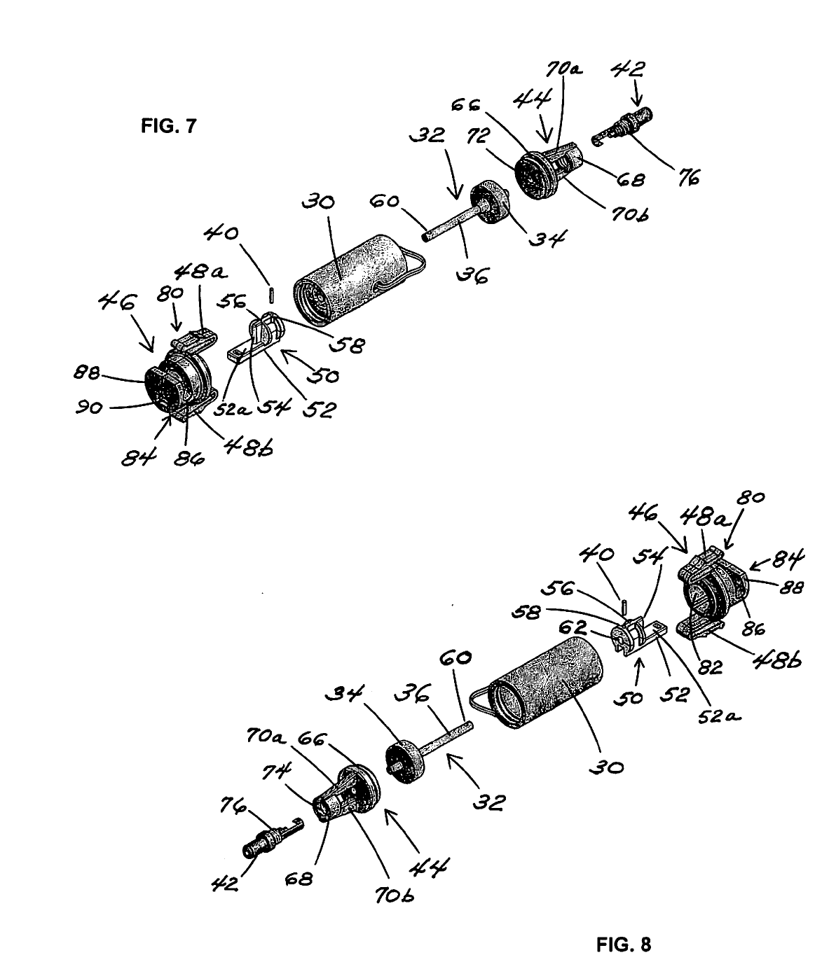

Referring now to FIG. 7, 8, and 9, a normally open tube pinch type solenoid valve 16 comprises a solenoid enclosure 30, a core 32, which comprises a head 34 and a slide shaft 36, a coil (not shown), a connecting pin 40, an electrical connector 42, a rear cap 44, a snap-in mount 46 having flexible mounting ears 48a, 48b, and a valve plunger 50. Additional details relating to the snap-in mount 46 are discussed later. The connecting pin 40 connects the slide shaft 36 to the valve plunger 50. The valve plunger 50 comprises a base 52 and a pinch device 54. The base 52 is an elongated element that is integral with the pinch device 54. The base 52 includes an extension 52a in the shape of a rectangular parallelepiped that extends away from the pinch device 54 and toward the snap-in mount 46. The upper surface 56 of the pinch device 54 has an opening 58 for receiving the connecting pin 40. The slide shaft 36 of the core 32 has an opening 60 for receiving the connecting pin 40. The pinch device 54 has an opening 62 in the pinch device 54 for receiving the slide shaft 36. The slide shaft 36 is inserted into the opening 62, the opening 58 is in register with the opening 60, the connecting pin 40 is inserted into openings 58 and 60 to connect the slide shaft 36 of the core 32 with the pinch device 54. The rear cap 44 comprises a base 66 proximal to the solenoid enclosure 30 and another base 68 distal from the solenoid enclosure 30. The base 66 is separated from the base 68 by legs 70a and 70b. The base 66 communicates with the solenoid enclosure 30, and the base 68 communicates with the electrical connector 42. The base 66 has an opening 72 therein for receiving the end of the slide shaft 36. The base 68 has an opening 74 therein for receiving the electrical connector 42. It is preferred that the opening 74 be threaded to mate with a threaded portion 76 of the electrical connector 42. The parts solenoid enclosure 30, core 32, head 34, slide shaft 36, core spring 38, connecting pin 40, electrical connector 42, snap-in mount 46, valve plunger 50, base 66, and base 68 are shown as being cylindrical, but a cylindrical shape is not required for these parts.

The snap-in mount 46 further comprises a body 80 having an opening 82 therein for receiving the base 52 and the pinch device 54 of the valve plunger 50. Extending from the body 80 of the snap-in mount 46 is a generally L-shaped projection 84 having a base 86 and an element 88 extending from the base 86 at approximately a right angle. The tubing fits onto the base 86 between the body 80 and the element 88. The tubing is constrained in the snap-in mount 46 and just touches both the element 88, which functions as an anvil, and the base 52 of the valve plunger 50. The pinch device 54 functions as a hammer. In the element 88 is a slot 90. The slot 90 is shown as being elongated, but the slot 90 is not required to be of an elongated shape. The slot 90 receives the extension 52a of the base 52 of the valve plunger 50, thereby enabling the pinch device 54 of the valve plunger 50 to move in a direction so as to compress the tubing a sufficient amount to halt flow of the fluid through the tubing. The tubing rests on the upper surface of the base 52 of the valve plunger 50.

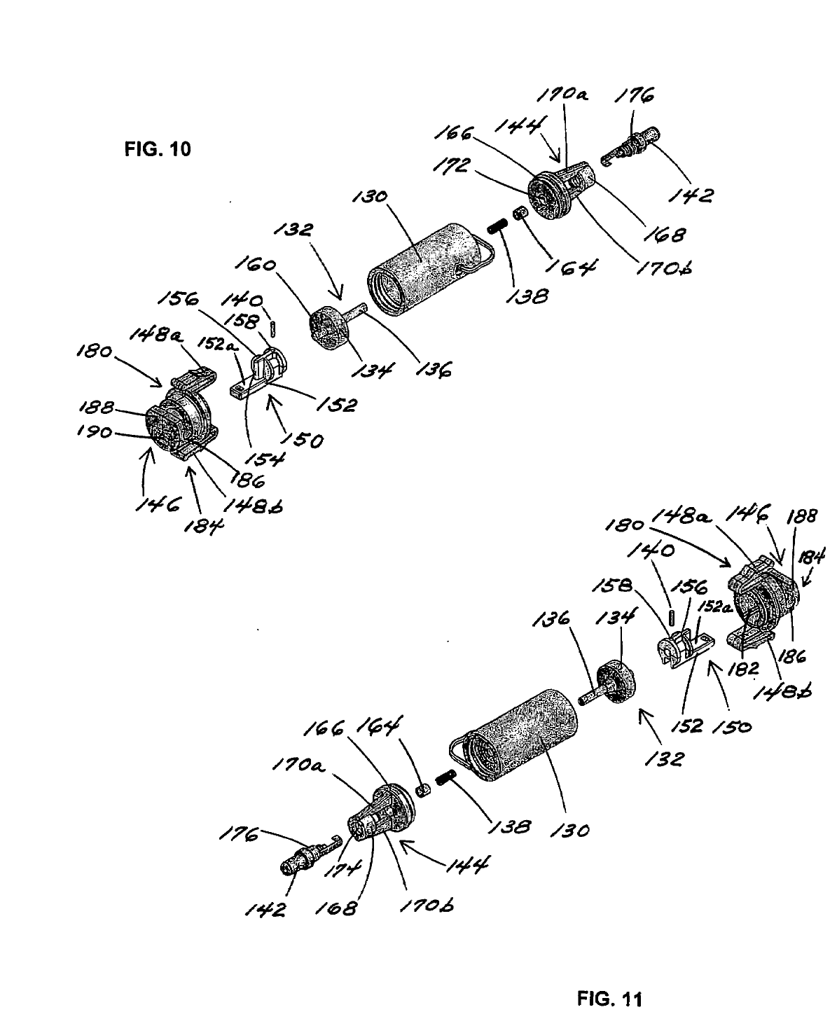

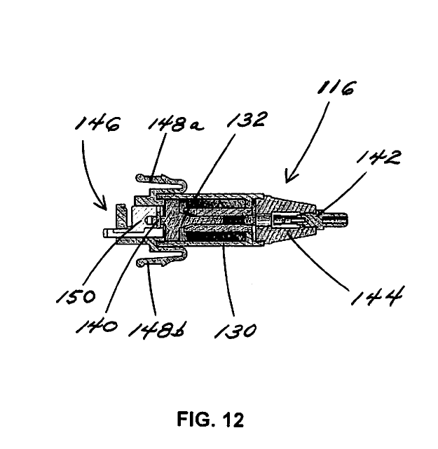

Referring now to FIGS. 10, 11, and 12, a normally closed tube pinch type solenoid valve 116 comprises a solenoid enclosure 130, a core 132, which comprises a head 134 and a slide shaft 136, a core spring 138, a coil (not shown), a connecting pin 140, an electrical connector 142, a rear cap 144, a snap-in mount 146 having flexible mounting ears 148a, 148b, and a valve plunger 150. Additional details relating to the snap-in mount 146 are discussed later. The connecting pin 140 connects the slide shaft 136 to the valve plunger 150. The valve plunger 150 comprises a base 152 and a pinch device 154. The base 152 is an elongated element that is integral with the pinch device 154. The base 152 includes an extension 152a in the shape of a rectangular parallelepiped that extends away from the pinch device 154 and toward the snap-in mount 146. The upper surface 156 of the pinch device 154 has an opening 158 for receiving the connecting pin 140. The slide shaft 136 of the core 132 has an opening 160 for receiving the connecting pin 140. The pinch device 154 has an opening 162 in the pinch device 154 for receiving the slide shaft 136. The slide shaft 136 is inserted into the opening 162, the opening 158 is in register with the opening 160, the pin is inserted into openings 158 and 160 to connect the slide shaft 136 of the core 132 with the pinch device 154. An adjusting screw 164 positioned between the base 166 and the core spring 138 enables the assembler of the tube pinch type solenoid valve 116 to set the force to a sufficiently high level to completely close, i.e., pinch, the tubing to regulate the flow of fluids through the tubing by means of the normally closed tube pinch type solenoid valve 116 only. If the force is insufficient, the tubing will not close completely, and unwanted fluid will be allowed to flow through the tubing. If the force is excessive, the solenoid will not overcome the resistance of the coil spring. The rear cap 144 comprises a base 166 proximal to the solenoid enclosure 130 and another base 168 distal from the solenoid enclosure 130. The base 166 is separated from the base 168 by legs 170a and 170b. The base 166 communicates with the solenoid enclosure 130, and the base 168 communicates with the electrical connector 142. The base 166 has an opening 172 therein for receiving the adjusting screw 164. The base 168 has an opening 174 therein for receiving the electrical connector 142. It is preferred that the opening 174 be threaded to mate with a threaded portion 176 of the electrical connector 142. The parts solenoid enclosure 130, core 132, head 134, slide shaft 136, core spring 138, connecting pin 140, electrical connector 142, snap-in mount 146, valve plunger 150, base 166, and base 168 are shown as being cylindrical, but a cylindrical shape is not required for these parts.

The snap-in mount 146 further comprises a body 180 having an opening 182 therein for receiving the base 152 and the pinch device 154 of the valve plunger 150. Extending from the body 180 of the snap-in mount 146 is a generally L-shaped projection 184 having a base 186 and an element 188 extending from the base 186 at approximately a right angle. The tubing fits onto the base 186 between the body 180 and the element 188. The tubing is constrained in the snap-in mount 146 and just touches both the element 188, which functions as an anvil, and the base 152 of the valve plunger 150. The pinch device 154 functions as a hammer. In the element 188 is a slot 190. The slot 190 is shown as being elongated, but the slot 190 is not required to be of an elongated shape. The slot 190 receives the extension 152a of the base 152 of the valve plunger 150, thereby enabling the pinch device 154 of the valve plunger 150 to move in a direction so as to compress the tubing a sufficient amount to halt flow of the fluid through the tubing. The tubing rests on the upper surface of the base 152 of the valve plunger 150.

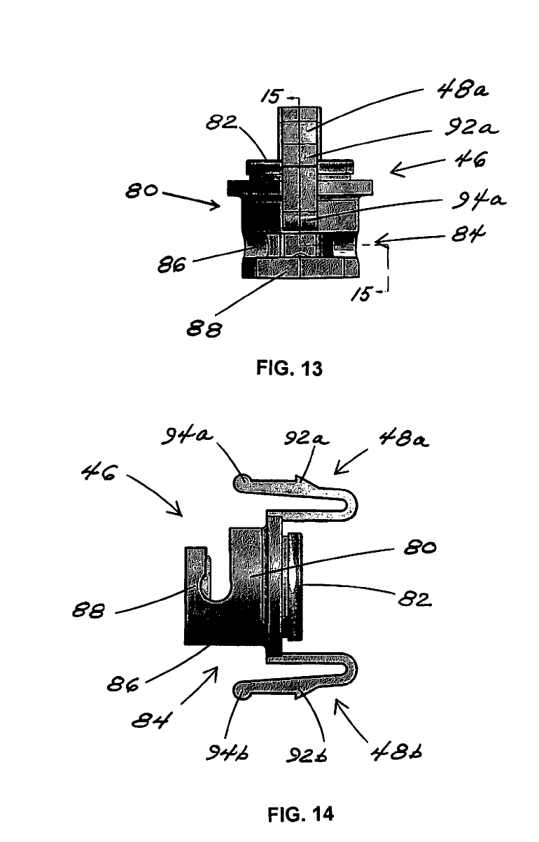

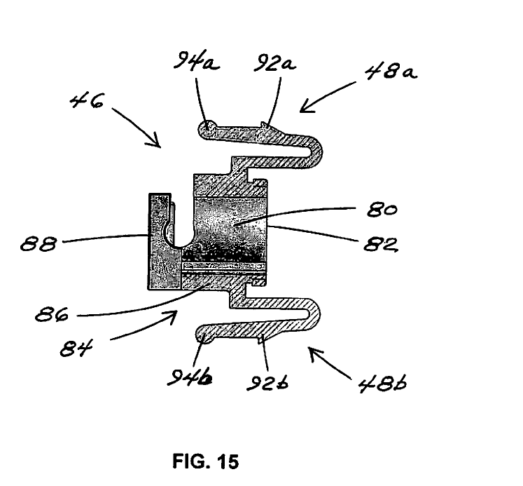

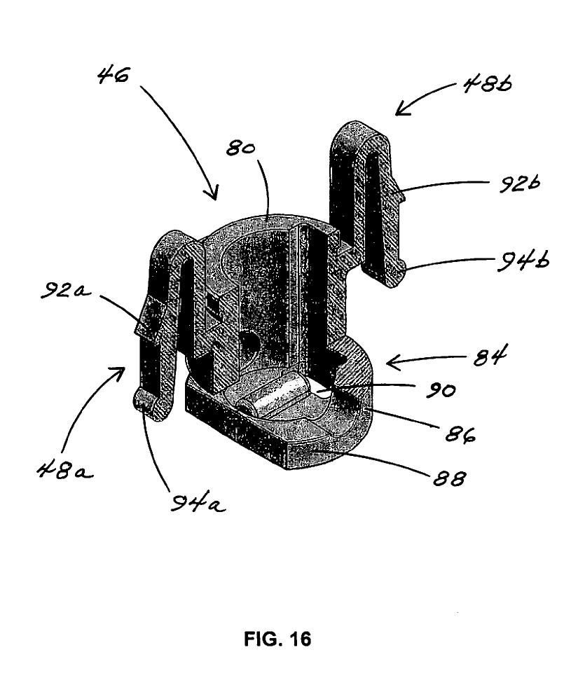

Referring now to FIGS. 13, 14, 15, and 16, the flexible mounting ears 48a, 48b have locking projections 92a, 92b, respectively, located intermediate the ends 94a, 94b, respectively, of the flexible mounting ears 48a, 48b, respectively, and the portions of the flexible mounting ears 48a, 48b that bends to form the lowermost portion of the “U” of the U-shape. The function of the locking projections 92a, 92b is to prevent the tube pinch type solenoid valve 16 from slipping out of the aperture 18 during use. The flexible mounting ears 48a, 48b preferably have gripping knobs located at the ends 94a, 94b, respectively, thereof. The function of the gripping knobs is to facilitate gripping of the ends 94a, 94b of the flexible mounting ears 48a, 48b, respectively, of the snap-in mount 46 by the installer when installing the snap-in mount 46 into the assembly 10 or removing the snap-in mount 46 from the assembly 10.

The flexible mounting ears 148a, 148b are substantially similar to the flexible mounting ears 48a, 48b, respectively, that are shown in FIGS. 13, 14, 15, and 16. Accordingly, the flexible mounting ears 148a, 148b have locking projections that are substantially similar to the locking projections 92a, 92b, respectively, shown in FIGS. 13, 14, 15, and 16. The locking projections of the flexible mounting ears 148a, 148b are located intermediate the ends of the flexible mounting ears 148a, 148b, respectively, that correspond to the ends 94a, 94b of the flexible mounting ears 48a, 48b, respectively, and the portions of the flexible mounting ears 148a, 148b that bends to form the lowermost portion of the “U” of the U-shape. As with the flexible mounting ears 48a, 48b, the function of the locking projections 92a, 92b is to prevent the tube pinch type solenoid valve 116 from slipping out of the aperture 18 during use. As with the flexible mounting ears 48a, 48b, the flexible mounting ears 148a, 148b preferably have gripping knobs located at the ends thereof substantially similar to the gripping knobs located at the ends 94a, 94b of the flexible mounting ears 48a, 48b, respectively. As with the flexible mounting ears 48a, 48b, the function of the gripping knobs of the flexible mounting ears 148a, 148b is to facilitate gripping of the ends of the flexible mounting ears 148a, 148b of the snap-in mount 146 by the installer when installing the snap-in mount 146 into the assembly 10 or removing the snap-in mount 146 from the assembly 10.

The flexible mounting ear 48a has a width different from that of the flexible mounting ear 48b, and the flexible mounting ear 148a has a width different from that of the flexible mounting ear 148b, so that the tube pinch type solenoid valve 16, 116 can be installed properly in the mounting panel 12, in accordance with the keyed orientation specified by the widths of the slots 18a and 18b at the periphery of the aperture 18.

In the following discussion of the normally open tube pinch type solenoid valve 16 and the normally closed tube pinch type solenoid valve 116, the names of like components in each type of tube pinch type solenoid valve will be followed by the reference numerals for both types of tube pinch type solenoid valves, where appropriate.

The core 32, 132 is a movable ferromagnetic rod, which is movable by magnetic forces. In a normally open tube pinch type solenoid valve, the core spring 164 keeps the core 132 in fixed position when the coil is de-energized. The solenoid enclosure 30, 130 is a metal housing around the coil (not shown) for electrical and mechanical protection, as well as ingress of water or dust. The snap-in mount 46, 146 is the structure that supports the tubing and provides a feature that enables pinching of the tubing. This supporting and pinching feature for the tubing is referred to herein as the valve seat or the anvil, as previously mentioned. The valve plunger 50, 150 is the moving portion of the tube pinch type solenoid valve that transfers the force generated by the solenoid to close the flow path of the tubing and restrict flow of fluid through the tubing. The valve plunger 50, 150 is attached to the core and contains a pinch device for pinching the tubing against the valve seat or anvil, as previously mentioned. The valve plunger 50, 150 is moved by energizing or de-energizing the solenoid. A direct current power source is applied to the wire coil in the solenoid body to energize the solenoid. The electric current generated by the direct current power source produces a magnetic field around the coil. This magnetic field in turn produces a magnetic force that causes the ferromagnetic core to be pulled to actuate the pinching mechanism. The design of the valve can be such that energizing it will cause the tubing to be pinched (for a normally open) valve, or un-pinched (for a normally closed) valve.

In the following discussion of the snap-in mount 46, 146, the names of like components in each type of tube pinch type solenoid valve will be followed by the reference numerals for both types of tube pinch type solenoid valves, where appropriate. However, because the snap-in mount 46 is substantially similar to the snap-in mount 146, only the parts for the snap-in mount 46 are shown in FIGS. 13, 14, 15, and 16. It is to be understood that the snap-in mount 146 has essentially the same construction as does the snap-in mount 46.

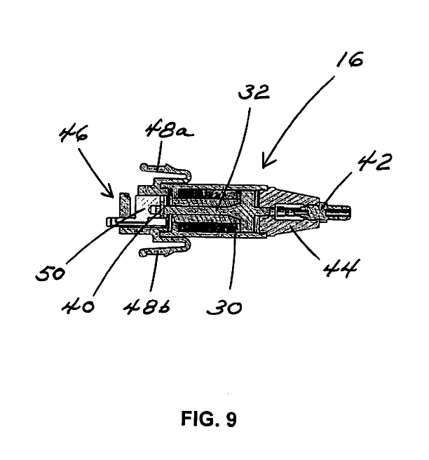

The snap-in mount 46 has substantially U-shaped flexible mounting ears 48a and 48b, as shown in FIGS. 7, 8, and 9, 148a and 148b, as shown in FIGS. 10, 11, and 12 to enable a snap-in mounting to the mounting panel 12. Referring now to FIGS. 13 and 14, in which only the snap-in mount 46 will be described, the snap-in mount 46 comprises a body 80 to which the U-shaped flexible mounting ears 48a, 48b are attached via a molding process. However, it is possible that the U-shaped flexible mounting ears 48a, 48b can be attached to the body 80 by a mechanical technique. The body 80 also has an opening 82 therein for receiving the base 52 and the pinch device 54 of the valve plunger 50. Extending from the body 80 of the snap-in mount 46 is a generally L-shaped projection 84 having a base 86 and an element 88 extending from the base 86 at approximately a right angle. The tubing fits onto the base 86 between the body 80 and the element 88. The tubing is constrained in the snap-in mount 46 and just touches both the element 88, which functions as the anvil, as previously mentioned, and the base 52 of the valve plunger 50. The pinch device 54 functions as the hammer, as previously mentioned. In the element 88 is a slot 90. The slot 90 receives the extension 52a of the base 52 of the valve plunger 50, thereby enabling the pinch device 54 of the valve plunger 50 to compress the tubing a sufficient amount to halt flow of the fluid through the tubing. The tubing rests on the upper surface of the base 52 of the valve plunger 50. The flexible mounting ears 48a, 48b have locking projections 92a, 92b, respectively, located intermediate the ends 94a, 94b, respectively, thereof and the portion of the flexible mounting ear 48a, 48b that bends to form the lowermost portion of the “U” of the U-shape. The function of the locking projections 92a, 92b is to prevent the tube pinch type solenoid valve 16, 116 from slipping out of the aperture 18 during use. The flexible mounting ears 48a, 48b preferably have gripping knobs located at the ends 94a, 94b, respectively, thereof. The function of the gripping knobs is to facilitate gripping of the ends 94a, 94b of the flexible mounting ears 48a, 48b, respectively, of the snap-in mount 46 by the user when installing the snap-in mount 46 into the assembly 10 or removing the snap-in mount 46 from the assembly 10. Again, it should be noted that the parts having the reference numerals 80, 82, 84, 86, 88, and 90 are substantially similar to those parts having the reference numerals 180, 182, 184, 186, 188, and 190.

The snap-in mount 46, 146 can be made by means of an injection molding technique. Injection molding is described in detail in Encyclopedia of Polymer Science and Technology, Vol. 8, John Wiley & Sons, Inc., 1987, pages 102-138, incorporated herein by reference. Materials suitable for preparing the snap-in mount 46, 146 include, but are not limited to, all thermoplastics, some thermosets, and some elastomers. Representative examples of polymers suitable for forming parts by injection molding include epoxy resins, phenolic resins, nylon, polyethylene, and polystyrene. While the particular material and the particular dimensions of the flexible mounting ears 48a, 48b are not critical, the material and the dimensions of the flexible mounting ears 48a, 48b are selected so that the flexible mounting ears 48a, 48b have sufficient rigidity, resilience, and flexibility to carry out their intended function of facilitating installation and removal of the of tube pinch type solenoid valve 16, 116, and retaining the tube pinch type solenoid valve 16, 116 while in use. One of ordinary skill in the art, such as, for example, a molding engineer, would be expected to have the ability to select proper material and dimensions for making flexible mounting ears 48a, 48b suitable for use with the snap-in mount 46 described herein.

The rear of the tubing pinch type solenoid valve 16, 116 has an electrical connector 42, 142 for attachment to a power jack 20 for power and ground connections. The electrical connector 42, 142 is inserted into a rear cap 44, 144. The rear cap 44, 144 is typically threaded, as is the electrical connector 42, 142, whereby the electrical connector 42, 142 can be attached to the rear cap 44, 144. The rear cap 44, 144 is designed so as to enable the wires leading from the solenoid to be conveniently connected to the electrical connector 44, 144. The rear panel 14 includes power jacks 20 for receiving the electrical connectors 42, 142 of the tube pinch type solenoid valve 16, 116 of the electrical connectors. A typical plug type electrical connector suitable for use herein has a barrel that fits onto the pin of the power jack 20. The power jacks 20 are connected with integral driver circuitry (not shown), whereby power is supplied for actuation of the tube pinch type solenoid valve 16, 116. The electrical connector 44, 144 allows the tube pinch type solenoid valve 16 to be mounted in any angular orientation in the mounting panel 12 as defined by the aperture 18 in the mounting panel 12. Contacts in the electrical connector 44, 144 allow for sensing the presence of an installed tube pinch type solenoid valve 16, 116, if necessary.

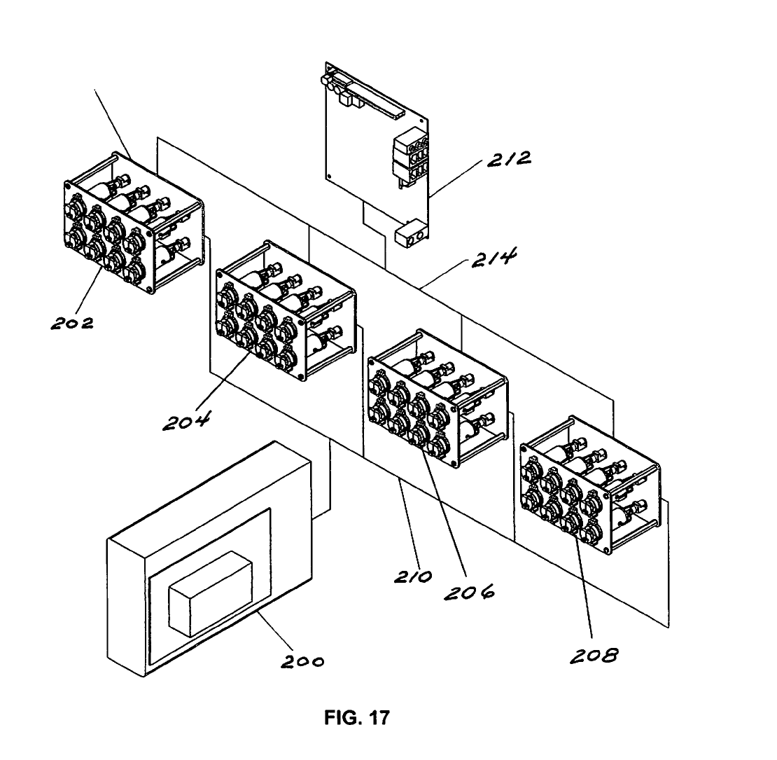

Referring now to FIG. 17, connections for a system that uses four assemblies 202, 204, 206, 208 for mounting tube pinch type solenoid valves are shown. A power supply unit 200 is connected to the assemblies 202, 204, 206, 208 by a power bus 210. A computer 212 is connected to the assemblies 202, 204, 206, 208 by a computer bus 214. As can be seen in FIG. 17, wires from the computer 212 to the assemblies 202, 204, 206, 208 for mounting tube pinch type solenoid valves need not cross one another; wires from the power supply unit 200 to the assemblies 202, 204, 206, 208 for mounting tube pinch type solenoid valves need not cross one another. Power buses and computer buses are well known to those of ordinary skill in the art.

There are numerous advantages brought about by the assembly for mounting tube pinch type solenoid valves described herein. The assembly simplifies insertion and removal of tube pinch type solenoid valves. The assembly brings about a great saving of time for both manufacturing the instruments and in servicing the instruments in the field. The tube pinch type solenoid valve can be installed into or removed from the mounting panel in a single motion, without the need for tools. No unattached hardware, e.g., mounting screws or nuts, is needed. Mechanical and electrical connections can be carried out in a procedure that involves only a single step. The circuit board contains the solenoid driver circuitry, with the result that there is no separate cable, connector, or circuit board. The three functions of the circuit board, i.e., the control of power and voltage to the solenoid valves, the power connection to the solenoid valves, and the routing of cables from the circuit board to the solenoid valves, are handled by a single component (the circuit board). The keyed orientation of valve assembly, e.g., the valve can be keyed to mount at any rotational angle, prevents improper installation of the valves. The assembly does away with routing electrical cables between circuit board and the solenoid valves. The round and centered electrical connector allows a solenoid valve to be oriented at any angle on the panel without changing or moving the matching connector on the circuit board.

### Operation

Referring now to FIGS. 1, 7, 8, 10, and 11, an assembly 10 comprising a mounting panel 12, a rear panel 14, and a sufficient number of connecting rods 26 to connect the mounting panel 12 to the rear panel 14 is provided. At least one tube pinch type solenoid valve 16, 116 is provided. The user inserts the electrical connector 42, 142 of the tube pinch type solenoid valve 16, 116 through the aperture 18 and guides the tube pinch type solenoid valve 16, 116 through the aperture 18 until the electrical connector 42, 142 mates with the power jack 20. It should be noted that because the aperture 18 has keyed slots 18a, and 18b, it is extremely difficult to insert the tube pinch type solenoid valve incorrectly. A vigorous attempt at incorrect insertion will most likely damage the tube pinch type solenoid valve. The flexible ears 48a, 48b, 148a, 148b of the snap-in mount 46, 146 are pressed inwardly by the material of the mounting panel 12 at the ends of the slots 18a, 18b furthest from the boundary of the aperture 18. Each flexible ear 48a, 48b, 148a, 148b is locked in proper position by the projections 92a, 92b thereon. The tube pinch type solenoid valve 16, 116 is now ready to receive tubing for fluids, typically liquids.

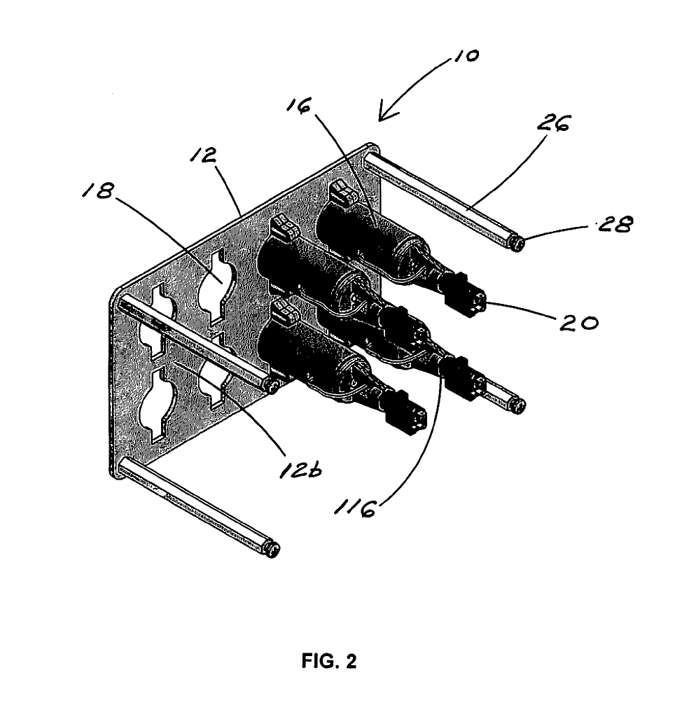

When the tube pinch type solenoid valve 16, 116 is to be removed for repair or replacement, the ends 94a, 94b of the flexible mounting ears 48a, 48b, 148a, 148b are squeezed inwardly to such an extent that the projections 92a, 92b are able to clear the front major surface 12a (see FIG. 1) and the rear major surface 12b (see FIG. 2) of the mounting panel 12, and the tube pinch type solenoid valve 16, 116 is withdrawn from the assembly 10; the electrical connector 42, 142 is removed from the power jack 20, and the entire length of the tube pinch type solenoid valve 16, 116 is drawn through the aperture 18.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. An assembly for mounting at least one tube pinch type solenoid valve comprising a mounting panel connected to a rear panel, said mounting panel having at least one aperture, said rear panel having at least one power jack, said at least one aperture having at least one keyed slot to ensure proper orientation of said tube pinch type solenoid valve.

2. The assembly of claim 1, wherein said at least one aperture has a plurality of keyed slots.

3. The assembly of claim 1, wherein said mounting panel has a plurality of apertures.

4. The assembly of claim 1, wherein said mounting panel is connected to said rear panel by at least one connecting rod.

5. The assembly of claim 4, wherein said mounting panel is connected to said rear panel by a plurality of connecting rods.

6. The assembly of claim 1, further including at least one tube pinch type solenoid valve.

7. The assembly of claim 1, further including a plurality of tube pinch type solenoid valves.

8. A normally open tube pinch type solenoid valve comprising a core tube, a core, a core spring, a solenoid enclosure, a slide shaft, an electrical connector, a snap-in mount having at least one flexible mounting ear, and a valve plunger.

9. The normally open tube pinch type solenoid valve of claim 8, wherein said snap-in mount has a plurality of flexible mounting ears.

10. The tube pinch type solenoid valve of claim 8, wherein said at least one snap-in mount comprises a recess for accommodating tubing, said at least one flexible mounting ear having a projection for gripping a major surface of the mounting panel.

11. A normally closed tube pinch type solenoid valve comprising a core tube, a core, a core spring, a solenoid enclosure, a slide shaft, an electrical connector, a snap-in mount having at least one flexible mounting ear, and a valve plunger.

12. The normally open tube pinch type solenoid valve of claim 11, wherein said snap-in mount has a plurality of flexible mounting ears.

13. The tube pinch type solenoid valve of claim 11, wherein said at least one snap-in mount comprises a recess for accommodating tubing, said at least one flexible mounting ear having a projection for gripping a major surface of the mounting panel.

14. A medical analyzer comprising at least one tube pinch type solenoid valve, said at least one tube pinch type valve mounted in an assembly for at least one tube pinch type solenoid valve, said assembly comprising a mounting panel connected to a rear panel, said mounting panel having at least one aperture, said rear panel having at least one power jack, said at least one aperture having at least one keyed slot to ensure proper orientation of said at least one tube pinch type solenoid valve.

15. The medical analyzer of claim 14, wherein said at least one aperture has a plurality of keyed slots.

16. The medical analyzer of claim 14, wherein said mounting panel has a plurality of apertures.

17. The medical analyzer of claim 14, further including a controller for operating said at least one tube pinch type solenoid valve.

18. The medical device of claim 14, further including a power source for said at least one tube pinch type solenoid valve.
